(19) United States
(12) Patent Application Publication
(10) Pub. No.: US 2020/0321829 A1
(43) Pub. Date: Oct. 8, 2020

(54) Speed Bump Power Generaion Drive

(71) Applicant: Victor Dmitriev, Moscow (RU)

(72) Inventor: Victor Dmitriev, Moscow (RU)

(21) Appl. No.: 16/372,881

(22) Filed: Apr. 2, 2019

(51) Int. Cl. H02K 7/18; H02K 11/00; H02K 7/06; H02K 7/108; E01F 9/529

(52) U.S. Cl. CPC H02K 7/1853; H02K 11/0094; E01F 9/529; H02K 7/108; H02K 7/06

(57) ABSTRACT

The invention is a road speed bump that generates electric current when a car runs it over. The generated electric energy can be utilized at user's discretion.

### BACKGROUND OF INVENTION

With limited resources of fossil fuels and problem of climate change a demand for alternative carbon-dioxide free sources of energy is growing worldwide. Large urban areas with heavy car traffic are main pollutants of environment, as well as largest consumers of fossil fuels and electric power. Limited space, expensive land and city infrastructure obstruct the installation of any power generating facilities in urban areas. Carbon-dioxide free, cost-efficient, easy to install, small scale power generating facilities are in great demand in cities.

### BRIEF SUMMARY OF INVENTION

The present invention is a cost-efficient electro-mechanical device that solves the described above problems by providing its users with significant amounts of carbon-dioxide free power in urban areas within proximity to power consumers, requires no city space compared to other known ecologically friendly power generating facilities. The amount of power generated by the invention does not depend on weather conditions as other ecologically-friendly power generation technologies do, like technologies based on wind and solar power. Since car traffic in most cities is constant at daytime—the invention provides stable and steady amounts of generated power, which grow proportionally to volume of traffic.

The present invention is specially designed street speed bump, which converts g-force and kinetic energy of a passing car into electric power.

To generate power the street bump works not only as a hump-like beam placed across the street pavement to slow down vehicle speed where slow down is required by safety reasons, but also as a pedal, which swings slightly up-and-down when the wheels of the car roll over it.

The working cycle of the invention consists of the following steps:

1. The pedal is in initial upper position when the vehicle approaches.

2. When front wheels of a vehicle roll over the pedal and force it to go slightly down the linear-to-rotational motion converting actuator, which is attached to the pedal accelerates the generator. The generator fly-wheels, generates power and charges the battery.

3. When front wheels of a vehicle roll off and release the pedal, it goes slightly up to its initial upper position, forced by a special spring.

The foregoing working cycle repeats when the rear wheels of the vehicle roll over the pedal. The same working cycle happens when the next car pass the speed bump.

Since weight and kinetic energy of any passing car are significant, the device provides short (couple of inches), but very forceful swings of the pedal. All embodiments of the invention transform these short swings of the pedal (street speed bump) into rotation of the generator.

### BRIEF DESCRIPTION OF DRAWINGS

The invention will now be explained in more detail with reference to a drawing, in which:

FIG. 1 shows perspective view of the invention, with pedal in initial upper position. The dimensional proportions of the pedal are changed for the purpose of illustration;

FIG. 2 shows side view of the invention, with pedal in initial upper position;

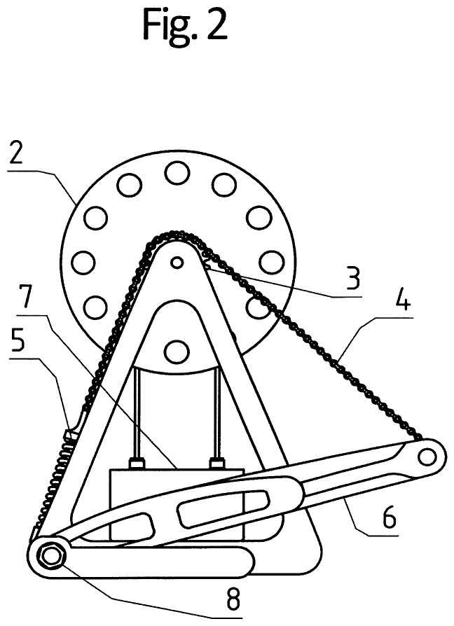

### DETAILED DESCRIPTION OF THE INVENTION

As it is described in summary of invention all embodiments of the invention use a power generator to produce electricity. As such, there are a great number of prior art designs of generators currently known and used for power generation (DC generators, AC generators including synchronous and asynchronous subsets, alternators, permanent magnet or electro-magnet based generators, etc.). Herein the term “generator” is an umbrella term, which defines all applicable in the invention designs of power generators and all suitable generators may be resorted to, falling within the scope of the invention.

Other than an embodiment with chain-and-sprocket actuator is an embodiment with belt-and-pulley actuator, which works the same way as chain-and-sprocket actuator but with pulley used instead of sprocket and a piece of belt used instead of chain.

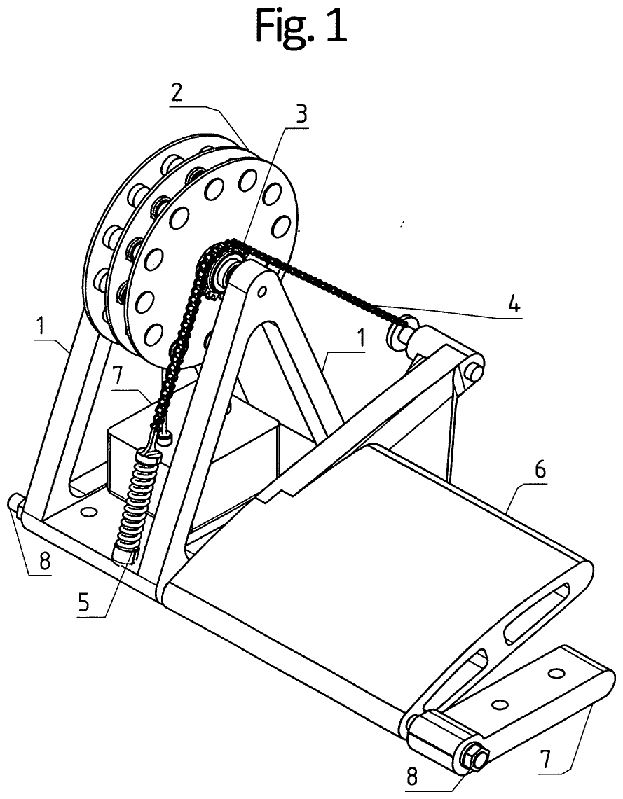

The front and perspective view of embodiment of the invention with chain-and-sprocket actuator is shown at FIG. 1 and is assembled the following way:

A frame 1 is placed on the roadside. The generator 2 is installed on the top of the frame 1. A sprocket with the over-running clutch 3 is installed on the rotor of generator 2. The construction of the sprocket with over-running clutch 3 is similar to the ones used in rear wheel axles of the bicycles and is prior art. The sprocket 3 accelerates the rotor of the generator 2 in one direction, but when the sprocket 3 is turned in the opposite direction it free runs with no affect on rotation of the rotor of generator 2. A chain 4 is coupled with sprocket 3. One end of the chain 4 is fixed to a spring 5, which in turn is fixed to frame 1; the other end of the chain 4 is fixed to swing arm of the pedal 6, which works as a street bump. The pedal 6 is showed relatively short for illustration purposes. The length of pedal 6 should fit the street lane width so all wheels of the car could cross it. The fixing bar 7 is installed on the other side of the street to fix the axle 8 on the other side of the street. The axle 8 can be coupled with frame 1 or fixed separately on the pavement of the street depending on particular requirements and conditions of use of the invention. The design, where axle 8 of the pedal is not connected to the frame 1 is an embodiment of the invention.

When wheels of a car roll-over the pedal 68, the pedal 6 goes slightly down around its axle 8 and pull the chain 4, which in turn rotates the sprocket with over-running clutch 3 of the generator 2 and stretches the spring 5. Rotating over-running clutch 3, accelerates the rotor of the generator 2. When the pedal 6 reaches its bottom position and touches the pavement of the road, it stops pulling the chain 4 down and a sprocket with over-running clutch stops, but the rotor of the generator 2 continues to turn by its own fly-wheel momentum in the same direction, since it is coupled with sprocket via over-running clutch, just like the rear will of a bicycle keeps turning when a rider has stop turning pedals.

When wheels of a car roll off the pedal 6, the spring 5 pulls the chain 4 back, which in turn pulls the pedal 6 in its initial (upper) position. The over-running clutch 3 enables the rotor of the generator 2 to continue its fly-wheel motion in the same direction, even when the chain 4 moves in the opposite direction to the rotation of the rotor of the generator 2.

As long the rotor rotates the generator 2 produces electric power, which accumulates via AC/DC converter circuit in the battery 7. A particular design of electric circuit used in the invention is prior art, deemed to be known by ones skilled in the art. Herein the design of the battery 7 with corresponding circuit is shown schematically and is out of the scope of the invention. The accumulated energy in battery 7 can be utilized at user discretion.

With respect to the above description then, it is to be realized that the optimal dimensional relationships for the parts of invention, to include variations in size, materials, form, gear ratios and number of gears, location and spatial orientation, linear-to-rotational actuator choice are subject to optimization in particular conditions of operation and are deemed readily apparent and obvious to one skilled in the art, and all equivalent relationships to those illustrated in the drawings and described in the specification are intended to be encompassed by present invention.

Therefore, the foregoing is considered as illustrative only of the principles of work of the invention. Further, since numerous modifications and changes will readily occur to those skilled in art, it is not desired to limit the invention to the exact construction and operation shown and described and, accordingly, all suitable modifications and equivalents may be resorted to, falling within the scope of the invention.

1. A speed bump power generation drive with chain-and-sprocket linear-to-rotational actuator comprising:
a frame;
a generator installed on this frame, wherein the axle of the rotor of the said generator is coupled with sprocket with over-running clutch;
a said sprocket with over-running clutch coupled with chain;
a said chain with one end coupled with the spring and other end coupled with the pedal;
a said spring with one end coupled with said chain and other end coupled with said frame;
a said pedal coupled with said frame;
a side fixing bar on the other side of the street coupled with the said pedal on the other side of the street;
a battery powered by the said generator.
